(19) United States
(12) Patent Application Publication
(10) Pub. No.: US 2009/0159799 A1
(43) Pub. Date: Jun. 25, 2009

(54) COLOR INFRARED LIGHT SENSOR, CAMERA, AND METHOD FOR CAPTURING IMAGES

(75) Inventors: Keith Gary Copeland, Tucson, AZ (US); Kevin Alfred Toerne, Tucson, AZ (US)

Correspondence Address: FENNEMORE CRAIG, P.C., 1700 Lincoln Street, SUITE 2900, DENVER, CO, 80203, US

(73) Assignee: SPECTRAL INSTRUMENTS, INC., Tucson, AZ (US)

(21) Appl. No.: 11/960,302

(22) Filed: Dec. 19, 2007

(51) Int. Cl. G01J 5/00

(52) U.S. Cl. 250/338.1

(57) ABSTRACT

A light sensor may include an array of light sensitive elements and an array of transmissive filters provided over the array of light sensitive elements and in substantial registration therewith. The array of transmissive filters comprises an infrared transmissive filter that substantially transmits infrared light and substantially blocks visible light as well as at least one non-infrared transmissive filter that substantially transmits non-infrared light.

### TECHNICAL FIELD

This invention relates to electronic image sensing in general and more specifically to multi-spectral imaging.

### BACKGROUND

Electronic imaging systems are well-known in the art and are used in a wide variety of applications. One type of system, known generally as a “true color” imaging system, may be used to obtain images based on data from the visible portion of the electromagnetic (i.e., light) spectrum. Images obtained by such systems approximate the images seen by the human eye, hence the name “true color.” Another type of imaging system, often referred to as a “false color” system, obtains images based, in whole or in part, on data from the non-visible portion of the electromagnetic spectrum. The image data collected from the non-visible portion of the electromagnetic spectrum are then shifted or converted into colors in the visible spectrum in the resulting image. Consequently, certain colors of the resulting image do not correspond to the actual or true color of the object when viewed by the human eye, but rather represent spectral data from the non-visible region, now made visible to the human eye by the conversion process.

A common example of a false color imaging system is “color infrared” system wherein the image data are collected from light in both the visible and infrared portions of the electromagnetic spectrum. Consequently, such false color infrared imaging systems contain additional information about the imaged object, i.e., information that cannot be derived from the visible spectrum alone. For example, color infrared false color imaging systems may be configured to provide stark color contrast where infrared reflectivity is high or low. As a result, such false color infrared imaging systems may be used to advantage in the aerial reconnaissance, geographical, law enforcement, resource management, and agricultural fields, just to name a few.

### SUMMARY OF THE INVENTION

One embodiment of a light sensor according to the present invention may include an array of light sensitive elements and an array of transmissive filters provided over the array of light sensitive elements and in substantial registration therewith. The array of transmissive filters comprises an infrared transmissive filter that substantially transmits infrared light and substantially blocks visible light as well as at least one non-infrared transmissive filter that substantially transmits non-infrared light.

Another embodiment of a light sensor may comprise a two-dimensional array of light sensitive elements and an array of transmissive filters provided over the two-dimensional array of light sensitive elements and in substantial registration therewith. The array of transmissive filters comprises an infrared transmissive filter as well as first, second, and third color transmissive filters. The infrared transmissive filter substantially transmits light in an infrared wavelength range and substantially blocks light in the visible wavelength range. The first, second, and third color transmissive filters transmit light in respective first, second, and third wavelength ranges. The infrared, first, second, and third wavelength ranges are generally consecutive and progress from long wavelength ranges to short wavelength ranges. The infrared, first, second, and third color transmissive filters are arranged over the two-dimensional array of light sensitive elements so that no two transmissive filters having consecutive wavelength ranges are located adjacent one another along at least one dimension of the two-dimensional array of light sensitive elements.

A method for capturing an image of an object may comprise: Providing a light sensor having an array of light sensitive elements arranged in a plurality of rows and columns and an array of transmissive filters positioned over the array of light sensitive elements and in substantial registration therewith, the array of transmissive filters comprising an infrared transmissive filter and at least one visible color transmissive filter, the infrared transmissive filter and the at least one visible color transmissive filter being arranged in columns; moving the light sensor and the object with respect to one another in a direction of motion that includes a component that is substantially aligned with the columns of the infrared transmissive filter and the at least one visible color transmissive filter; and sensing electrical signals from the light sensitive elements; and compensating for the relative movement of said light sensor and the object in the direction of motion.

Also disclosed is a camera that comprises a light sensor having an array of light sensitive elements thereon and an array of transmissive filters provided over the array of light sensitive elements and in substantial registration therewith. The array of transmissive filters comprises an infrared transmissive filter and at least one visible color transmissive filter. The infrared transmissive filter substantially transmits infrared light and substantially blocks visible light. An optical assembly operatively associated with the array of light sensitive elements forms an image of an object on the array of light sensitive elements. A signal processor operatively associated with the array of light sensitive elements processes output signals from the array of light sensitive elements and produces multi-spectral image data containing infrared spectral information and visible color information, wherein the camera lacks a filter for preventing infrared light from reaching the entirety of the array of transmissive filters.

### BRIEF DESCRIPTION OF THE DRAWINGS

Illustrative and presently preferred exemplary embodiments of the invention are shown in the drawings in which:

FIG. 1 is a simplified schematic representation of a camera according to one embodiment of the present invention;

FIG. 2 is an enlarged perspective view of one embodiment of an image sensor and color filter array;

FIG. 3 is a schematic representation of a first embodiment of a color filter array;

FIG. 4 is a plot of transmission percent versus wavelength for various visible color and infrared transmissive filters;

FIG. 5 is a schematic representation of a second embodiment of a color filter array;

FIG. 6 is a schematic representation of a third embodiment of a color filter array; and

FIG. 7 is a schematic representation of a fourth embodiment of a color filter array.

### DETAILED DESCRIPTION OF THE PREFERRED EMBODIMENTS

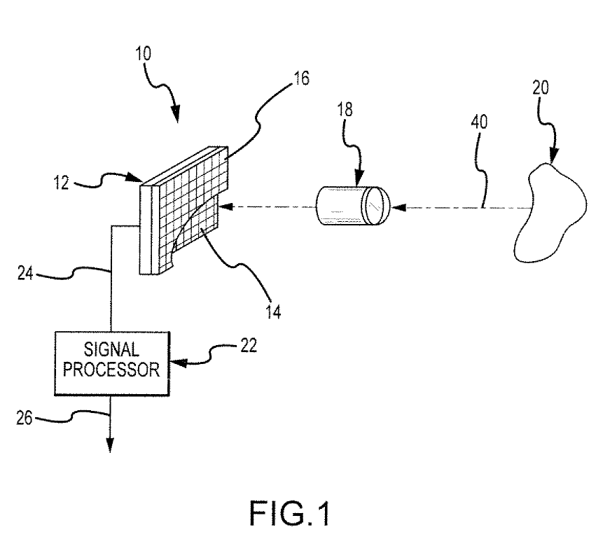

A camera 10 according to one embodiment of the present invention is illustrated in FIG. 1 and may comprise a light sensor 12 having an array of light sensitive elements 14. An array of transmissive filters (i.e., a color filter array) 16 is provided on the light sensor 12 so that individual ones of the transmissive filters 16 are in substantial alignment or registration with the individual ones of the light sensitive elements 14. As will be described in much greater detail herein, the array of transmissive filters 16 may comprise at least one infrared transmissive filter and at least one filter that transmits non-infrared light, such as, for example, a visible color transmissive filter. The camera 10 may also include an optical assembly 18 for forming an image of an object 20 on the light sensor 12. A signal processor 22 operatively associated with the light sensor 12 processes output signals 24 from the array of light sensitive elements 14 and produces multi-spectral image data 26. In one embodiment, the multi-spectral image data 26 may comprise infrared spectral information and visible color information, although other spectral combinations are possible.

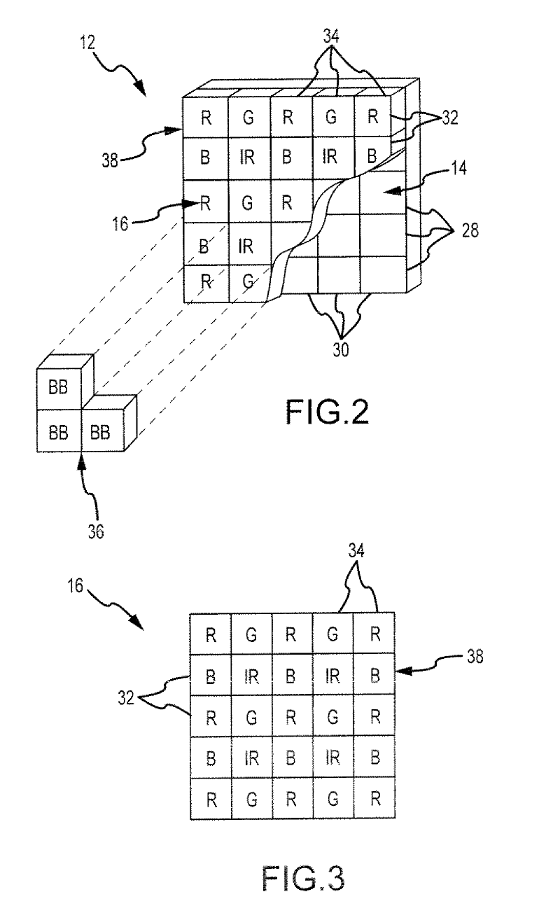

Referring now primarily to FIGS. 2 and 3, one embodiment of the light sensor 12 may comprise a two-dimensional array of light sensitive elements 14 arranged in a plurality of rows 28 and columns 30. The array of light sensitive elements 14 may comprise a charge coupled device (CCD), although other sensor devices are known and may be used. A variety of different kinds or colors of transmissive filters 16 are provided on the light sensor 12 so that the various ones of the transmissive filters 16 are in substantial alignment or registration with the various ones of the light sensitive elements 14, as best seen in FIG. 2. In one embodiment, the transmissive filters 16 comprise three visible color transmissive filters, red (R), green (G), and blue (B), although other colors, either within or without the visible spectrum, may also be used. In addition to the visible color filters, the array of transmissive filters 16 may also comprise an infrared (IR) transmissive filter. The infrared (IR) transmissive filter substantially transmits infrared light and substantially blocks visible light. Consequently, camera 10 utilizing light sensor 12 may be use to capture both true color and false color images of object 20 in the manner that will be described in further detail herein.

The various transmissive filters 16 may be arranged in accordance with any of a wide variety of patterns, several of which are shown and described herein. A first embodiment of a pattern 38 for the array of transmissive filters 16 is illustrated in FIGS. 2 and 3 and comprises a plurality of rows 32 and columns 34 that, as already mentioned, are substantially aligned with the various rows and columns 28 and 30 of the array of light sensitive elements 14. In the particular pattern illustrated in FIGS. 2 and 3, the array of transmissive filters 16 is configured so that the various transmissive filters 16 comprise various rows 32 of alternating red (R) and green (G) transmissive filters 16 and various rows 32 of alternating blue (B) and infrared (IR) transmissive filters 16. The rows 32 are arranged so that they form columns 34 of alternating red (R) and blue (B) transmissive filters 16 and columns 34 of alternating green (G) and infrared (IR) transmissive filters 16.

It is generally preferred, but not required, to configure the array of transmissive filters 16 so that no two transmissive filters 16 having consecutive wavelength ranges are located adjacent one another along at least one dimension of the two-dimensional array of light sensitive elements 14. So configuring the array of transmissive filters 16 (i.e., to maximize the distance between pixels sensing wavelengths of similar spectral ranges) provides for improved image quality and generally allows more spectral data to be gathered by the light sensor 12. An example of this type of configuration is illustrated in FIGS. 2 and 3, in which no two transmissive filters 16 having consecutive wavelength ranges are located adjacent one another in the various columns 34. That is, a first column 34 comprises alternating arrangements of red (R) and blue (B) transmissive filters 16, which are not colors in consecutive wavelength ranges, whereas an adjacent column comprises alternating arrangements of green (G) and infrared (IR) transmissive filters 16, which are also not colors in consecutive wavelength ranges.

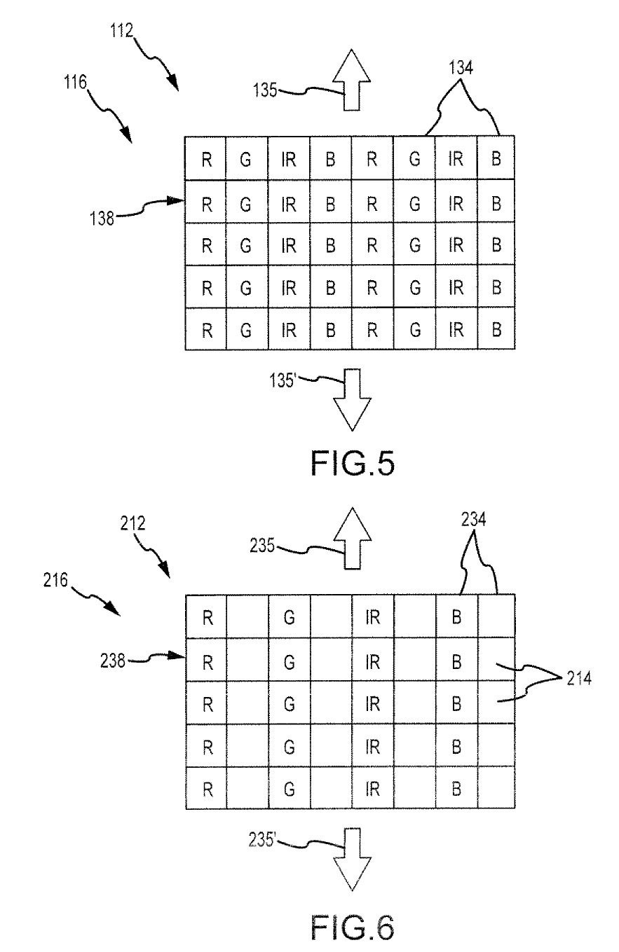

Other patterns or configurations for the various transmissive filters 16 are possible and may be advantageous in certain applications. For example, a striped pattern or configuration 138 is illustrated in FIG. 5 and involves an array of transmissive filters 116 having a plurality of columns 134, each of which comprises a single type or color of transmissive filter 116. More specifically, pattern 138 involves a first stripe or column 134 of red (R) transmissive filters 116. A second stripe or column 134 may comprise green (G) transmissive filters 116, whereas third and forth stripes or columns 134 include infrared (IR) and blue (B) transmissive filters 116, respectively. The striped pattern 138 then repeats in the manner illustrated in FIG. 5. As will be described in greater detail below, a striped configuration wherein the various columns (e.g., 134) of the array of transmissive filters 116 comprise a single type or color of transmissive filter provides the ability to compensate for the relative movement of the light sensor and the object being imaged along a direction of motion (e.g., indicated by arrows 135 and 135′) that is generally parallel to the various color stripes or columns 134. Stated another way, the arrangement in columns 134 of the various types or colors of the transmissive filters 116 allows for relative movement of the light sensor and object in the column direction (i.e., 135, 135′) to be more easily compensated than would otherwise be the case.

In addition to the aspects of the invention already described, it is generally preferred, but not required, that the various types or colors comprising the array of transmissive filters 16 be as “pure” as possible to promote good color reproduction and to minimize cross talk between color bands. For example, the blue color band is generally regarded as comprising light having wavelengths in a range of about 400 nanometers (nm) to about 500 nm. Therefore, it is generally preferred (but not required) that the blue transmissive filter transmit a substantial portion of incident light within this wavelength range or band. Likewise, the green color band is generally regarded as including light having wavelengths in a range of about 500 nm to about 600 nm, whereas the red color band is generally regarded as covering wavelengths in a range of about 600 nm to about 700 nm. Consequently, the green and red transmissive filters 16 should transmit a substantial portion of incident light within these respective wavelength ranges or bands. The infrared band is generally regarded as including wavelengths longer than about 700 nm and may extend up to wavelengths as long as about 1100 nm. Therefore, the infrared transmissive filter 16 should transmit a substantial portion of light within this infrared wavelength range or band.

In this regard it should be noted that many of the dyes used for the visible color transmissive filters (e.g., the red, green, and blue filters) comprising the array of transmissive filters 16 have infrared “leaks.” That is, while such color transmissive filters do a good job of transmitting a substantial portion of the incident light within their respective wavelength ranges, they also transmit light in the infrared band, i.e., wavelengths greater than about 700 nm. Consequently, it may be advantageous to provide a broadband (BB) color transmissive filter 36 adjacent the various color transmissive filters (but not the infrared (IR) transmissive filter) to prevent light in the infrared region from reaching the corresponding light sensitive elements 14. Broadband (BB) color transmissive filter 36 may be deposited on top of the various visible color transmissive filters (e.g., R, G, and B) in the manner best seen in FIG. 2. Alternatively, and as will be described in further detail below, the material comprising broadband (BB) color transmissive filter 36 may be mixed with the materials or dyes comprising the various visible color transmissive filters (e.g., R, G, and B) and applied at the same time as the various color transmissive filters. In still another variation, the signal processor 22 may be configured to compensate for infrared leakage through the various color transmissive filters in a manner that will be described in further detail below.

The camera 10 may be used as follows to capture an image of object 20 that includes both visible color spectral information and infrared spectral information. Assuming that the camera 10 has been provided with a light sensor 12 in accordance with the teachings provided herein, the camera 10 may capture an image of object 20 by exposing the light sensor 12 to light (e.g., represented by arrow 40) from the object 20 that is focused on light sensor 12 by lens system 18. The array of transmissive filters 16 removes or filters undesired wavelengths from light 40, allowing only light of the desired wavelength band to reach the corresponding light sensitive elements 14 of light sensor 12. More specifically, and in the embodiment shown and described in FIGS. 1-3, only blue light (i.e., light having wavelengths in the range of about 400 nm to about 500 nm) will reach the light sensitive elements 14 that are aligned with the blue (B) transmissive filters 16. Similarly, only light having wavelengths in the green (i.e., 500-600 nm) and red (i.e., 600-700 nm) bands will reach the light sensitive elements 14 that are aligned with the green (G) and red (R) transmissive filters 16, respectively. The infrared (IR) transmissive filters will allow only light having wavelengths in the infrared band (i.e., generally longer than about 700 nm) to reach the corresponding the light sensitive elements 14. Signal processor 22 will then capture the output signals 24 from the various light sensitive elements 14 and process them as necessary to produce multi-spectral image data 26. Thereafter, the multi-spectral image data may be color-shifted to produce a false color image of object 20, wherein the infrared spectral component is displayed as any desired color in the visible color spectrum. Alternatively, a true color image may be produced by ignoring the infrared spectral component.

If it is expected that there will be relative motion between the camera 10 and the object 20 during the exposure period, then it may be desirable to use a light sensor (e.g., 112) wherein the array of transmissive filters (e.g., 116) are arranged in stripes or columns, such as, for example, the striped pattern 138 illustrated in FIG. 5. The light sensor should be arranged so that the relative motion between the camera and image occurs along a direction (e.g., 135, 135′) that is generally parallel to the various color stripes or columns 134. Signal processor 22 may then compensate for the relative motion during the data read-out and conversion process.

A significant advantage of the present invention is that the array of transmissive filters is integral with the light sensor 12. Consequently, a camera system utilizing the light sensor 12 need not be provided with separate color filters or separate image sensors for each color band. In addition, the camera system need not be provided with a separate infrared filter to prevent infrared light from reaching the visible color sensing components. As a result, a camera system according to the teachings provided herein can be readily used to generate both true color images and false color images (e.g., color infrared images) without the need to provide a dedicated infrared light sensor and without the need to utilize a separate infrared filter in the optical system.

Still other advantages are associated with the various patterns for the array of transmissive filters. For example, an embodiment wherein the pattern is arranged so that no two transmissive filters having consecutive wavelength ranges or bands are located adjacent one another along at least one dimension of the two-dimensional array of light sensitive elements provides for improved image quality and generally allows more spectral data to be captured by the light sensor than would otherwise be the case. Further, an embodiment wherein the pattern of the array of transmissive filters comprises various color stripes (i.e., columns made up of a single type or color of transmissive filter) provides a convenient means for compensating for relative motion between the object and the sensor that may occur during the exposure period.

Still other advantages are associated with the provision of the broadband (BB) transmissive filters 36. The broadband filters 36 effectively block or prevent infrared light from reaching the various color transmissive filters (e.g., the red (R), green (G) and blue (B) filters), thereby allowing color filters to be used regardless of the degree of infrared leakage that may be associated with the filters. The broadband (BB) filters 36 also dispense with the need to compensate for the undesired infrared component during processing of the image data. The broadband (BB) filter material or dye may also be mixed with the various color dyes to produce a composite dye that substantially transmits light in the desired wavelength range while at the same time substantially blocking light in the infrared wavelength range. The resulting mixture or composite dye may then be applied in a single step, thereby simplifying production.

Having briefly described the camera 10 and light sensor 12 according to the present invention, as well as methods for using the same, various exemplary embodiments of cameras, light sensors, and methods for capturing images will now be described, in detail. However, before proceeding with the detailed description, it should be noted that embodiments shown and described herein are exemplary only. For example, the embodiments shown and described herein utilize three color transmissive filters in the red, green, blue, and infrared spectral ranges in order to both allow true and false color images to be reproduced. However, other combinations of transmissive light filters (e.g., in the visible spectrum, the non-visible spectrum, and various combinations thereof) may be used for this purpose, as would become apparent to persons having ordinary skill in the art after having become familiar with the teachings provided herein. In addition, while the exemplary embodiments shown and described herein utilize CCD light sensors, other types of light sensors that are known in the art or that may be developed in the future could also be used. Consequently, the present invention should not be regarded as limited to the particular components, configurations, and wavelength ranges shown and described herein.

Referring back now to FIGS. 1-3 simultaneously, a camera 10 according to one embodiment of the present invention may comprise a light sensor 12 having plurality of light sensitive elements or pixels 14 provided thereon. In the embodiment shown and described herein, the various light sensitive elements or pixels 14 comprising light sensor 12 are arranged so that they define a two-dimensional array having a plurality of rows 28 and columns 30, as best seen in FIG. 2. Light sensor 12 may comprise any number of light sensitive elements 14. In most applications, the number of light sensitive elements 14 will number in the millions or tens of millions, although a greater or lesser number of pixels 14 may be provided.

Light sensor 12 may comprise any of a wide range of electronic light sensors, such as CCD sensors or CMOS sensors, that are now known in the arc or that may be developed in the future, that are, or would be, suitable for the particular application. Consequently, the present invention should not be regarded as limited to any particular type of light sensor. However, by way of example, in one embodiment, light sensor 12 comprises a charge-coupled device (CCD).

The light sensor 12 is also provided with an integral array of transmissive filters 16 that are applied to the light sensor 12 so that they are substantially aligned or in registration with the various light sensitive elements 14. See FIG. 2. In one embodiment, the array of transmissive filters 16 comprises three visible color transmissive filters (e.g., red (R), green (G), and blue (B) transmissive filters), as well as an infrared (IR) transmissive filter. Consequently, light sensor 12 may be used to create both true color and false color images in the manner described herein.

The number of different visible color transmissive filters used will depend to some degree on the desired visible portion of the spectrum that is to be captured as well as on the size of the color gamut that is desired to be reproduced. Generally speaking, three different visible color filters will provide good color reproduction. In the embodiments shown and described herein, the three visible color transmissive filters 16 may comprise red (R), green (G), and blue (B) color transmissive filters, although other color filter combinations are known and may be used as well.

The red (R), green (G), and blue (B) color transmissive filters 16 may comprise any of a wide range of color filter dyes that are now known in the art or that may be developed in the future that are (or would be) suitable for the particular light sensor being used. Consequently, the present invention should not be regarded as limited to any particular type of transmissive filter 16. However, by way of example, in one embodiment, the red (R) transmissive filter may comprise a filter dye available from Brewer Science, Inc., of Rolla, Mo. (US) and sold under the trademark “PSC Red.” The green (G) transmissive filter may comprise a filter dye available from Brewer Science, Inc., sold under the trademark “PSC Green,” whereas the blue (B) transmissive filter may comprise a Brewer Science dye sold under the trademark “PSC Blue.” The dyes comprising the various visible color transmissive filters may be applied by any of a wide variety of techniques now known in the art or that may be developed in the future. By way of example, the Brewer Science filter dyes specified herein may be applied by any of a wide range of photolithography processes that are now known in the art or that may be developed in the future that are or would be suitable for applying the transmissive color filter dyes to light sensor 12.

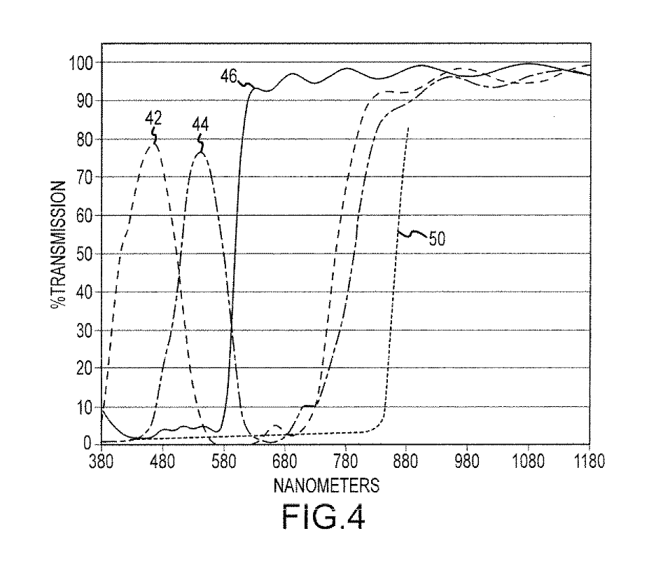

It is generally desired, but not required, that the various color transmissive filters substantially transmit a large portion of light in the desired wavelength band while rejecting light in other wavelength bands to promote good color reproduction and to minimize cross talk between color bands. As already mentioned, the blue color band is generally regarded as including light having wavelengths in the range of about 400-500 nanometers (nm), whereas the green and red color bands are generally regarded as including light having wavelengths in the range of about 500-600 nm and 600-700 nm, respectively. Consequently, the transmissive color filters should transmit a substantial portion of light within these wavelength bands. Exemplary transmission characteristics representative of the Brewer Science dyes specified herein are illustrated in FIG. 4. More specifically, the transmission curve 42 for the blue transmissive filter (e.g., “PSC Blue” at a thickness of about 1.65 μm) indicates a high transmittance in the blue wavelength band (e.g., between about 400 nm and 500 nm). Similarly, the transmission curves 44 and 46 for green and red transmissive filters, respectively (e.g., “PSC Green” at a thickness of about 1.75 μm, and “PSC Red” at a thickness of about 1.65 μm), indicate high transmittances in the green and red wavelength bands.

However, all of the transmission curves 42, 44, and 46 for the various color transmissive filter dyes specified herein indicate some degree of transmission in the infrared wavelength range (i.e., wavelengths of 700 nm or greater). That is, the various red (R), green (G), and blue (B) color transmissive filters 16 represented in FIG. 4 have some degree of infrared “leakage.” Consequently, it may be advantageous to provide a broadband (BB) color transmissive filter 36 adjacent the various visible color transmissive filters (e.g., R, G, and B) in order to prevent light in the infrared region from reaching the corresponding light sensitive elements 14.

As its name implies, broadband color transmissive filter 36 substantially transmits light in the visible color region (i.e., from about 400 nm to about 700 nm), while substantially blocking light of shorter and longer wavelengths. Of particular interest in the present invention is the ability of the broadband (BB) color transmissive filter to substantially block light having wavelengths longer than about 700 nm.

Broadband (BB) color transmissive filter 36 may comprise any of a wide range of broadband color transmissive filters known in the art or that may be developed in the future that are (or would be) suitable for the particular application. Consequently, the present invention should not be regarded as limited to any particular broadband color transmissive filter. However, by way of example, in one embodiment, the broadband color transmissive filter 36 may comprise a near infrared absorption material or dye of the type disclosed in U.S. Pat. No. 7,018,714, issued Mar. 28, 2006, to Kobayashi et al., and entitled “Near-Infrared Absorption Film,” which is specifically incorporated herein by reference for all that it discloses. The material disclosed in U.S. Pat. No. 7,018,714 is characterized by having excellent near-infrared blocking properties and visible light transparency over a wide wavelength range.

The material comprising the broadband color transmissive filter 36 disclosed in U.S. Pat. No. 7,018,714 may be mixed with the various color dyes used for the various color transmissive filters (e.g., R, G, and B). The resulting mixtures or composite dyes, which are transmissive in the various color wavelength bands (e.g., red, green, and blue), but not transmissive in the infrared band, can then be applied by any of a wide range of processes (e.g., photolithography) suitable for applying such materials. In an alternative arrangement, the broadband color transmissive filter material 36 may be applied as a separate coating or layer on either side of the various visible color transmissive filters 16 (e.g., either on top of or underneath the color transmissive filters 16), as would become apparent to persons having ordinary skill in the art after having become familiar with the teachings provided herein. Consequently, the present invention should not be regarded as limited to any particular arrangement for combining the various visible color transmissive filters (e.g., R, G, B) and the broadband (BB) color transmissive filter.

The infrared (IR) transmissive filter functions in a manner similar to the visible color transmissive filters. More specifically, infrared (IR) transmissive filter substantially transmits light in the infrared wavelength band (i.e., light having wavelengths longer than about 700 nm). However, infrared (IR) filter also substantially blocks light in the visible wavelength band (i.e., light having wavelengths between about 400 nm to about 700 nm). See, for example, transmission curve 50 illustrated in FIG. 4. The infrared transmissive filter may comprise any of a wide range of filters or filter dyes now known in the art or that may be developed in the future having a high transmittance for wavelengths longer than about 700 nm and through at least about 1100 nm and substantially no transmittance in the visible wavelength range. Consequently, the present invention should not be regarded as limited to any particular type of infrared (IR) transmissive filter. However, by way of example, in one embodiment, infrared transmissive filter may comprise a black polyimide material available from Brewer Science, Inc., of Rolla Mo. (US) and sold under the trademark “DARC 400,” which is a registered trademark of Brewer Science, Inc. The infrared transmissive filter may be applied by any of a wide variety of techniques now known in the art or that may be developed in the future that are or would be suitable for applying such materials. By way of example, the black polyimide IR filter dye specified herein may be applied by a photolithography process during manufacture of the light sensor 12.

The various transmissive filters 16 described herein may be arranged in accordance with any of a wide variety of patterns or configurations. For example, a first embodiment of a pattern 38 for arranging the array of transmissive filters 16 is illustrated in FIGS. 2 and 3 and comprises a plurality of rows 32 and columns 34 that are substantially aligned with the various rows and columns 28 and 30 of the array of light sensitive elements 14 in the manner already described. In the particular pattern illustrated in FIGS. 2 and 3, the array of transmissive filters 16 is configured so that the various transmissive filters 16 comprise various rows 32 of alternating red (R) and green (G) transmissive filters 16 and various rows 32 of alternating blue (B) and infrared (IR) transmissive filters 16. The various rows 32 are arranged so that they form columns 34 of alternating red (R) and blue (B) transmissive filters 16 and columns 34 of alternating green (G) and infrared (IR) transmissive filters 16.

As briefly described above, it is generally preferred, but not required, to configure the array of transmissive filters 16 so that no two transmissive filters 16 having consecutive wavelength ranges are located adjacent one another along at least one dimension of the two-dimensional array of light sensitive elements or pixels 14. Such a configuration maximizes the distance between pixels sensing wavelengths of similar spectral ranges, thereby providing for improved image quality and generally allowing more spectral data to be gathered by the light sensor 12. One example of this type of configuration is illustrated in FIGS. 2 and 3, in which no two transmissive filters 16 having consecutive wavelength ranges are located adjacent one another in the various columns 34. More specifically, a first column 34 comprises alternating arrangements of red (R) and blue (B) transmissive filters 16, whereas an adjacent column comprises alternating arrangements of green (G) and infrared (IR) transmissive filters 16.

Still other patterns or configurations are possible for arranging the various transmissive filters 16 and may be used to advantage in certain applications. One such application is an application (e.g., aerial photography) wherein the camera 10 is expected to move somewhat with respect to the object 20 during the exposure period. Another such application is in the food inspection field in which a fixed camera may be used to capture images of food (e.g., fresh fruits and vegetables) that may be moving along a conveyor system. Such relative motion between the camera 10 and the object 20 may result in color mis-registration or “smearing” as the image moves slightly across the image sensor during the exposure period. Such color mis-registration may be more easily compensated if the columns of the pattern comprise a single color or “stripe” and if the light sensor is oriented so that the direction of motion is generally parallel to the color stripes or columns.

Referring now primarily to FIG. 5, a second embodiment of a pattern or configuration 138 of the array of transmissive filters 116 comprises a plurality of columns 134, each of which comprises a single type or color of transmissive filter 116. More specifically, pattern 138 may comprise a first column 134 having all red (R) transmissive filters 116, whereas a second column 134 comprises all green (G) transmissive filters 116. Third and fourth columns 134 comprise infrared (IR) and blue (B) transmissive filters 116, respectively.

As was briefly described above, a light sensor 212 comprising a configuration wherein the various columns (e.g., 134) of the array of transmissive filters 116 comprise a single type or color of transmissive filter allows relative motion between the light sensor 212 and object (e.g., 20, FIG. 1) to be more readily compensated when that motion occurs in a direction 135, 135′ that is generally parallel to the various color stripes or columns 234 of light sensor 212. Such motion compensation can be accomplished via the signal processor (e.g., 22) associated with the light sensor 212 (e.g., by the selective “readout” of the pixel data).

A third embodiment 238 of a pattern or configuration of the array of transmissive filters 216 is illustrated in FIG. 6 and comprises a plurality of columns 234, each of which comprises a single type or color of transmissive filter 216. In the embodiment illustrated in FIG. 6, the pattern 238 comprises various columns 234 of red (R), green (G), infrared (IR) and blue (B) transmissive filters 216. However, unlike the embodiments 38 and 138 already described, pattern 238 also includes a plurality of columns 234 that lack any transmissive filters 216. These columns 234 are left blank in FIG. 6 to indicate that no transmissive filters 216 are present for these pixels 214. Thus, the unfiltered pixels 214 are panchromatic pixels, in that they will respond to light of all wavelengths within the sensing ability of the pixels 211. As was the case for pattern 138 illustrated in FIG. 5, the columnar or striped arrangement of the transmissive filters 216 of pattern 238 allows relative motion (i.e., in the directions indicated by arrows 235 and 235′) between the sensor and object to be more easily compensated (e.g., during subsequent processing of the collected image data).

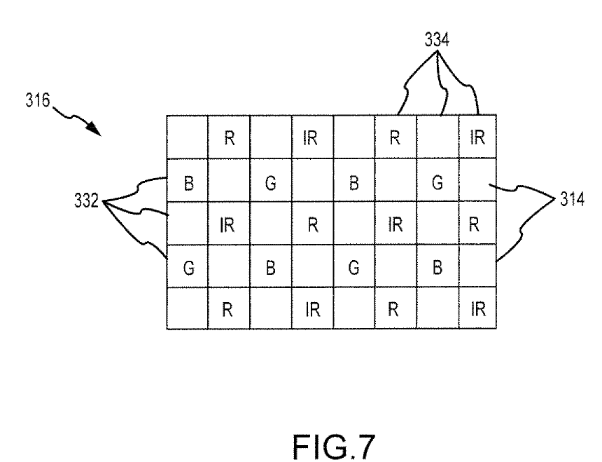

A fourth embodiment of a pattern 338 for the array of transmissive filter 316 is illustrated in FIG. 7 and comprises a “checkerboard” arrangement of transmissive filters. More specifically, a first row 332 may comprise alternating red (R) and infrared (IR) transmissive filters 316 separated by pixels 214 that have no transmissive filters associated with them. A second row 332 may comprise alternating blue (B) and green (G) transmissive filters, again separated by pixels 314 having no transmissive filters over them. The unfiltered pixels 314 are also panchromatic pixels and will respond to light of ail wavelengths, within the sensing ability of the pixels 314.

The camera 10 may be used as follows to capture an image of object 20 that includes both visible color spectral information and infrared spectral information. That is, light 40 reflected by object 20 is panchromatic. Camera 10 may capture an image of object 20 by exposing the light sensor 12 to light 40 from the object 20 that is focused on light sensor 12 by lens system 18. The array of transmissive filters 16 removes or filters undesired wavelengths from the panchromatic light 40, allowing only light of the desired wavelength band to reach the corresponding light sensitive element 11 of light sensor 12. More specifically, and in the embodiment shown and described in FIGS. 1-3, only blue light will reach the light sensitive elements 14 that are aligned with the blue (B) transmissive filters 16. Similarly, only light having wavelengths in the green and red spectral bands will reach the light sensitive elements 14 that are aligned with the green (G) and red (R) transmissive filters 16, respectively. The infrared (IR) transmissive filters will only permit light having wavelengths in the infrared band (i.e., generally longer than about 700 nm) to reach the corresponding the light sensitive elements 14. Signal processor 22 will then capture the output signals 24 from the various light sensitive elements 14 and process them as necessary to produce multi-spectral image data 26. Thereafter, the multi-spectral image data may be color-shifted to produce a false color image of object 20 wherein the infrared spectral component is displayed as any desired color in the visible color spectrum. Alternatively, a true color image may be produced by ignoring the infrared spectral component.

As discussed above, it is generally preferred that the red (R), green (G) and blue (B) dyes transmit only light in their respective color wavelength bands. However, if the color transmissive filters 16 have infrared light leaks that are not compensated for by the addition of a broadband (BB) transmissive filter 36, then the image data from the red, green, and blue pixels will contain infrared spectral information in addition to the desired red, green, and blue spectral information. The undesired infrared spectral information may be removed during subsequent processing of the image data. For example, one compensation strategy may be for the signal processor 22 to determine the magnitude of the undesired infrared spectral information based on the signals produced by one or more infrared (IR) pixels that are nearby the particular red (R), green (G), or blue (B) pixel for which the data are to be compensated. The infrared spectral component, as determined from a nearby infrared pixel or pixels, then may be subtracted from the spectral component from the red, green, and blue pixels in order to produce compensated data for the visible color pixels.

If it is expected that there will be relative motion between the camera 10 and the object 20 during the exposure period, then it will be generally desirable to use a light sensor wherein the array of transmissive filters are arranged in various stripes or columns (e.g., patterns 138, 238, illustrated in FIGS. 5 and 6). The light sensor should be arranged so that the relative motion between the camera and image occurs along a direction (e.g., 135, 135′, 235, 235′) that is generally parallel to the various stripes or columns 134, 234. Signal processor 22 (FIG. 1) may then compensate for the relative motion during the data readout and conversion process. By way of example, the compensation for the relative motion between the camera 10 and the object 20 may be accomplished by shifting the readout of the pixels in direction of motion (e.g., 135, 135′, 235, 235′), i.e., along the columns 134, 234 of the light sensor.

Having herein set forth preferred embodiments of the present invention, it is anticipated that suitable modifications can be made thereto which will nonetheless remain within the scope of the invention. The invention shall therefore only be construed in accordance with the following claims:

1. A light sensor, comprising:
an array of light sensitive elements; and
an array of transmissive filters provided on the array of light sensitive elements and in substantial registration therewith, said array of transmissive filters comprising an infrared transmissive filter that substantially transmits infrared light and substantially blocks visible light and at least one non-infrared transmissive filter that substantially transmits non-infrared light.

2. The light sensor of claim 1, wherein said at least one non-infrared transmissive filter further comprises a first color filter, a second color filter, and a third color filter.

3. The light sensor of claim 2, wherein said first color filter comprises a red transmissive filter, said second color filter comprises a green transmissive filter, and said third color filter comprises a blue transmissive filter.

4. The light sensor of claim 3, wherein said red transmissive filter transmits light having wavelengths in a range of about 600 nm to about 700 nm, wherein said green transmissive filter transmits light having wavelengths in a range of about 500 nm to about 600 nm, wherein said blue transmissive filter transmits light having wavelengths in a range of about 400 nm to about 500 nm, and wherein said infrared transmissive filter transmits light having wavelengths longer than about 700 nm.

5. The light sensor of claim 1, wherein said array of light sensitive elements comprises a CCD array.

6. The light sensor of claim 1, wherein said array of light sensitive elements comprises a CMOS array.

7. The light sensor of claim 1, wherein said array of light sensitive elements comprises a two-dimensional array comprising a plurality of rows of light sensitive elements and a plurality of columns of light sensitive elements.

8. The light sensor of claim 7, wherein said at least one non-infrared transmissive filter comprises a red transmissive filter, a green transmissive filter, and a blue transmissive filter, and wherein said array of transmissive filters further comprises a row of alternating red and green transmissive filters and a row of alternating blue and infrared transmissive filters.

9. The light sensor of claim 8, wherein the row of alternating blue and infrared transmissive filters is positioned with respect to the row of alternating red and green transmissive filters so that a first column of transmissive filters comprises alternating red and blue transmissive filters and so that a second column of transmissive filters comprises alternating green and infrared transmissive filters.

10. The light sensor of claim 7, wherein said at least one non-infrared transmissive filter comprises a red transmissive filter, a green transmissive filter, and a blue transmissive filter, and wherein said array of transmissive filters comprises a column of red transmissive filters, a column of green transmissive filters, a column of infrared transmissive filters, and a column of blue transmissive filters.

11. The light sensor of claim 10, wherein said column of green transmissive filters is next to said column of red transmissive filters, said column of infrared transmissive filters is next to said column of green transmissive filters, and said column of blue transmissive filters is next to said column of infrared transmissive filters.

12. The light sensor of claim 10, wherein said array of transmissive filters comprises alternating columns having no filters between each of said columns of red, green, infrared, and blue transmissive filters.

13. The light sensor of claim 10, further comprising a broadband transmissive color filter provided adjacent the red, green, and blue transmissive filters, said broad band transmissive color filter transmitting light having wavelengths in a range of about 400 nm to about 700 nm.

14. The light sensor of claim 1, wherein said infrared transmissive filter comprises a polyimide material.

15. The light sensor of claim 14, wherein said polyimide material substantially blocks light having wavelengths of less than about 700 nm.

16. The light sensor of claim 15, wherein said polyimide material substantially transmits light having wavelengths in a range of about 700 nm to about 1100 nm.

17. The light sensor of claim 14, wherein said polyimide material comprises DARC® 400.

18. A light sensor, comprising:
an array of light sensitive elements; and
an array of transmissive filters provided over the array of light sensitive elements and in substantial registration therewith, said array of transmissive filters comprising an infrared transmissive filter and at least one visible color transmissive filter, the infrared transmissive filter substantially transmitting infrared light and substantially blocking visible light.

19. A method for capturing an image of an object, comprising:
providing a light sensor, said light sensor comprising:
an array of light sensitive elements arranged in a plurality of rows and columns; and
an array of transmissive filters provided over the array of light sensitive elements and in substantial registration therewith, said array of transmissive filters comprising an infrared transmissive filter and at least one visible color transmissive filter, said infrared transmissive filter and said at least one visible color transmissive filter being arranged in columns;
moving said light sensor and the object with respect to one another in a direction of motion that includes a component that is substantially aligned with the columns of said infrared transmissive filter and said at least one visible color transmissive filter;
sensing electrical signals from the light sensitive elements; and
compensating for the relative movement of said light sensor and the object in the direction of motion.

20. A light sensor, comprising:
a two-dimensional array of light sensitive elements; and
an array of transmissive filters provided over said two-dimensional array of light sensitive elements and in substantial registration therewith, said array of transmissive filters comprising an infrared transmissive filter, a first color transmissive filter, a second color transmissive filter, and a third color transmissive filter, said infrared transmissive filter substantially transmitting light in an infrared wavelength range and substantially blocking light in a visible wavelength range, said first color transmissive filter transmitting light a first wavelength range, said second color transmissive filter transmitting light in a second wavelength range, said third color transmissive filter transmitting light in a third wavelength range, the infrared, first, second, and third wavelength ranges being generally consecutive and progressing from long wavelength ranges to short wavelength ranges, said infrared, first, second, and third color transmissive filters being arranged so that no two transmissive filters having consecutive wavelength ranges are located adjacent one another along at least one dimension of said two-dimensional array of light sensitive elements.

21. A camera, comprising:
a light sensor, said light sensor comprising:
an array of light sensitive elements; and
an array of transmissive filters provided over the array of light sensitive elements and in substantial registration therewith, said array of transmissive filters comprising an infrared transmissive filter and at least one visible color transmissive filter, the infrared transmissive filter substantially transmitting infrared light and substantially blocking visible light;
an optical assembly operatively associated with said array of light sensitive elements, said optical assembly forming an image of an object on said array of light sensitive elements; and
a signal processor operatively associated with said array of light sensitive elements, said signal processor processing output signals from said array of light sensitive elements to produce multi-spectral image data containing infrared spectral information and visible color information, wherein said camera lacks a filter for preventing infrared light from reaching the entirety of the array of transmissive filters.
